(19) United States
(12) Patent Application Publication
(10) Pub. No.: US 2021/0114711 A1
(43) Pub. Date: Apr. 22, 2021

(54) COMPOSITE SPAR FOR A WING STRUCTURE

(71) Applicant: AIRBUS OPERATIONS LIMITED, Bristol (GB)

(72) Inventors: Thomas BARNETT, Bristol (GB); Lee PROUDLER, Bristol (GB); Andrew SCAIFE, Bristol (GB)

(21) Appl. No.: 17/050,585

(22) PCT Filed: Apr. 26, 2019
(86) PCT No.: PCT/EP2019/060703

§ 371 Date: Oct. 26, 2020

(30) Foreign Application Priority Data
Apr. 27, 2018 (GB) 1806888.2

(51) Int. Cl. B64C 3/18; B64C 23/06; B29C 70/48; B29C 70/22

(52) U.S. Cl. CPC B64C 3/185; B64C 23/069; B29L 2031/3085; B29C 70/222; B29C 70/48

(57) ABSTRACT

A composite spar is disclosed having a main body and a pair of spaced apart legs. The space between the legs permits access to the mandrel assembly within the spar in order to ease its removal. This arrangement permits a spar of any length and contour to be manufactured.

### FIELD OF TECHNOLOGY

This invention relates to a spar for a wing structure, such as a wingtip device, and particularly to such a spar that is made of composite material.

### BACKGROUND

A spar is a load-bearing structural element used in, for example, wings. Wing spars support the wing on the aircraft and, in flight, transmit lift generated by the wings to the fuselage of the aircraft. A spar may take many forms, but it has been found that box section spars provide good torsional stiffness. Therefore, a spar design having a box section along at least part of its length is preferred. Traditionally, spars have been made of metallic material. However, composite materials are becoming increasingly used because the resulting spar is generally lighter and stiffer than a conventional metallic spar.

A typical composite spar is fabricated by a process known as Resin Transfer Moulding (RTM). This process consists of applying a fibre “layup” to the surface of a mandrel that corresponds to the interior surface of the entire length of the spar cavity. A die corresponding to the exterior surface of the spar is then applied and the mould assembly is closed, sealed and heated. Heated resin is injected to impregnate the fibre layup. The mould assembly may be placed under vacuum to assist the flow of resin. The mould assembly is then held at an elevated temperature in order to cure the resin.

A problem which may be encountered with forming spars by means of RTM is that of removing the mandrel once the spar has been formed. The length of the mandrel makes it difficult to remove. Any variations in cross-sectional shape of the spar, or its contour, add to this difficulty. Certain desired configurations of spar are not possible to make by means of RTM because of the difficulty of removing the mandrel.

### BRIEF SUMMARY OF THE TECHNOLOGY

The invention provides a composite spar comprising a main body and a pair of spaced apart legs, in which the spar follows a curved path which does not lie in a single plane. The space between the legs permits a spar to be manufactured on a mandrel assembly having any desired length and contour, as the space allows access to the mandrel assembly within the spar in order to ease its removal. The provision of access to the interior of the spar allows for spars having more complex contours to be manufactured. Thus, a spar constructed according to the invention may be made to support a structure, such as a wing or winglet, of a more complex shape than was achievable hitherto.

Preferably, a first end portion of the spar comprises the main body and is arranged to lie in a first plane; the other end portion of the spar comprises the free end portions of the legs, which are arranged to lie in a second plane. The spar further comprises a curved transition region between the planes.

Advantageously, the main body is hollow. The hollow main body may be formed conventionally, as described above, but using a mandrel of much shorter length than was necessary hitherto, such that it is easier to remove.

Preferably, the legs are concave in section, with the openings facing each other. Thus, the legs together define an incomplete box section, which is structurally sturdy.

Each leg may have a c-shaped cross section, which allows the spar to provide support to structural components, such as wing skins, that may be mounted to the upper and lower portions of the c-shape.

The main body of the spar may be rectangular in cross section. This is the preferred configuration for providing torsional stiffness to the spar.

The invention further provides a method of forming such a composite spar comprising the steps of: laying a fabric on a mandrel assembly; laying a die assembly over the fabric; injecting liquid resin into the fabric and curing the fabric by applying an elevated temperature—in other words, the process known as Resin Transfer Moulding.

The mandrel assembly preferably includes a main body mandrel arranged to form the main body of the spar and which is slidably removable from the spar; a plurality of mandrel segments may also be provided and arranged to form the legs of the spar, each segment being slidably removable from the spar. Such a configuration of mandrel parts allows for relatively complex spar shapes to be made whilst still retaining the box section for the spar main body.

The mandrel segments may be interlockable, with each segment arranged to abut the next, so as to provide a good support surface across the entire length of the spar during its manufacture.

The composite spar may be incorporated in a wing tip device such as a winglet. A portion of the spar may be arranged to extend from the wing tip device so as to facilitate mounting of the wing tip device to the main body of a wing. The portion of the spar that extends from the wing tip device is preferably the main body portion.

The main body of the spar is preferably arranged to support the winglet at its root, with the legs providing support along at least part of the span of the winglet.

An aircraft wing structure including a spar constructed according to the present invention may comprise a wing main body and a wing tip device. Part of the spar, such as the main body, may protrude from the wing tip device and sit inside the wing main body. Such an arrangement provides a secure junction between the wing main body and the wing tip device.

### BRIEF DESCRIPTION OF THE DRAWINGS

The invention will now be described, by way of example, with reference to the accompanying drawings in which:

FIG. 1 is a perspective view of part of a spar constructed according to the invention;

FIG. 2 is a perspective view of mandrels used in forming the main body of the spar of FIG. 1;

FIG. 3 shows the main body of the spar of FIG. 1 with the mandrels of FIG. 2 in situ;

FIG. 4 is a perspective view of part of the spar of FIG. 1, showing part of a mandrel used to form the legs of the spar;

FIGS. 5a and 5b are perspective views of part of a wing structure incorporating the spar of FIG. 1;

FIG. 6 is a perspective view of a complete wing structure incorporating the part of FIGS. 5a and 5b;

FIG. 7a is a front view of an aircraft incorporating the wing structure of FIG. 6; and

FIG. 7b is a plan view of the aircraft of FIG. 6a.

### DETAILED DESCRIPTION OF EMBODIMENTS OF THE INVENTION

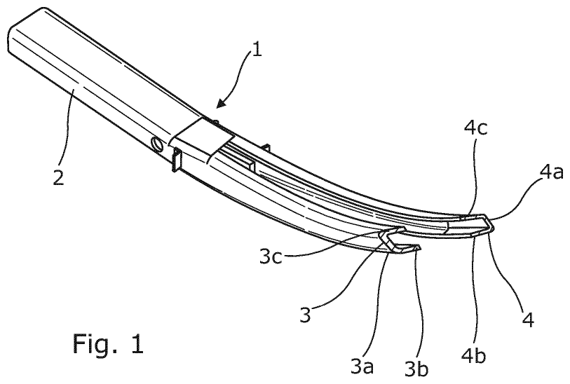

With reference to FIG. 1, part of a spar constructed according to the invention is indicated generally by the reference numeral 1. The spar 1 comprises a main body 2 and a pair 3, 4 of legs extending from the main body. The main body 2 has a hollow box structure that is rectangular in cross section. Such a structure provides good torsional stiffness. The main body 2 is elongated and extends in a straight line. The legs 3, 4 are longer than the main body 2 and follow a curved path which does not lie in a single plane. The legs 3, 4 extend further than is shown in this drawing. The legs 3, 4 are spaced apart from each other and have c-shaped cross sections arranged so that the convex parts of the respective c-shapes face one another. The squared-off c-shaped sections together form an incomplete box section. The cross section of the leg 3 mirrors that of the leg 4. The legs 3, 4 provide support for any structure to which the spar 1 is attached and usefully transmit loads experienced by the structure to the main body 2 of the spar 1. Each leg 3, 4 comprises a wall 3a, 4a, a lower flange 3b, 4b and an upper flange 3c, 4c. The flanges 3b, 4b, 3c, 4c provide respective attachment surfaces so that the spar can be fixed to the structure to which it provides support, such as the skins of a wing, by, for example, adhesion or mechanical fastening. The main body 2 and legs 3, 4 of the spar 1 are formed as one piece by an RTM method which will be outlined below.

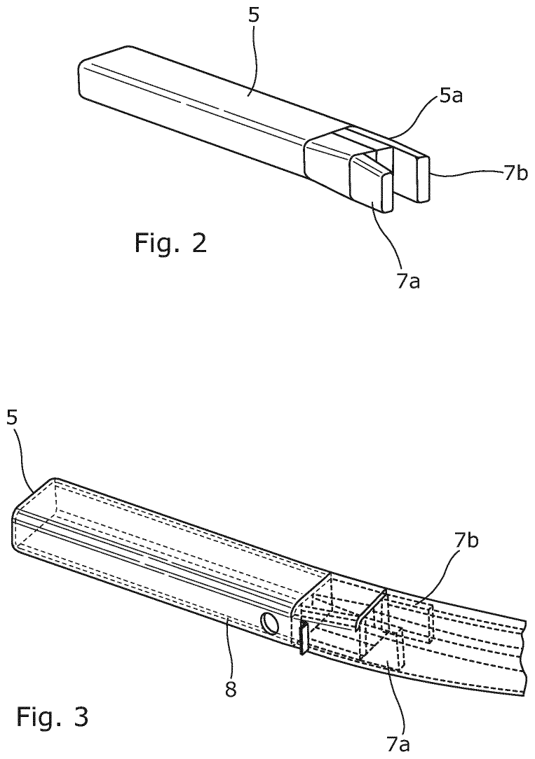

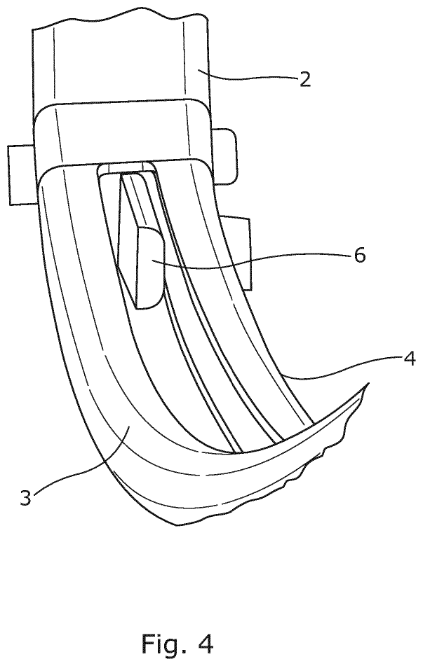

Firstly, the fibre layup is applied to the surface of a metallic mandrel assembly, part of which is shown in FIG. 2. The mandrel assembly comprises main body mandrel 5 and a plurality of mandrel segments 6, one of which is shown in FIG. 4. The main body mandrel 5 is a solid rectangular piece for forming the main body 2 of the spar 1. An end portion 5a of the mandrel 5 is arranged to form the first portion of the legs 3, 4. The end 5a has two protruding prongs 7a, 7b that define the inner contour of the legs 3, 4 respectively. The first mandrel segment 6 is arranged to abut the end 5a of the main body mandrel 5. Subsequent mandrel segments are laid up to form the inner convex contours of the legs 3, 4 of the spar in their entirety.

The fibre layup comprises a unidirectional (UD) fabric 8 (FIG. 3), which is one in which the majority of the fibres run in one direction only. In this embodiment, a so-called zero-degree fibre fabric is used, in which the fibres run along the length of the mandrel assembly. This arrangement of fibres gives good longitudinal strength of the finished spar. A small amount of fibre or other material may run in other directions, in order to strengthen the spar along its other axes. These fibres can also usefully hold the primary fibres in position. Of course, other materials could be used, such as woven mats, braided fibres or any other type of fibrous material known to the skilled person.

A die assembly corresponding to the exterior surfaces of the spar is then applied. The entire assembly of mandrels, fabric and dies (collectively, the “mould assembly”) is then closed and sealed. Heated liquid resin matrix material is then injected into the mould assembly, and the resin infuses the fabric throughout the mould cavity. A vacuum is created within the tool to assist the flow of liquid resin. The mould assembly is then held at an elevated temperature in order to cure the resin. When the resin has solidified, the mould assembly is released, the exterior dies are removed and then the mandrels are extracted from the completed spar 1.

During the demoulding process, the main body mandrel 5 may be slid out of the main body 2 as its relatively short length allows for easy removal. The mandrel segments 6 are removed by sliding them along the spar 1 to the end of the legs 3, 4, or else by sliding them laterally into the gap between the legs, and then upwardly or downwardly out of the spar. The space between the legs 3, 4 allows an operator easy access to the mandrel segments 6 to facilitate their removal, as is shown in FIG. 4. The finished spar 1 is then ready for use as a support structure.

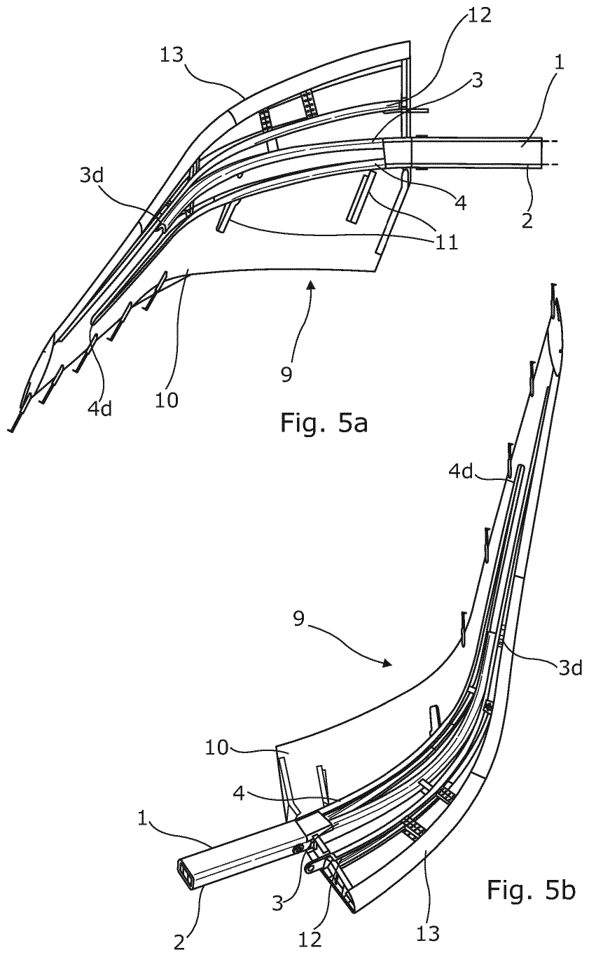

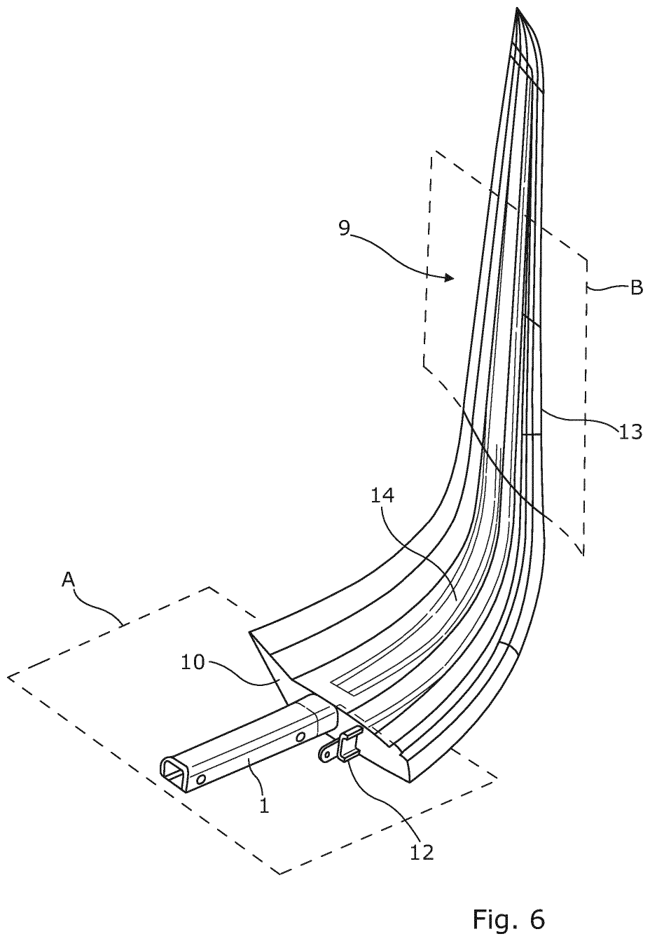

FIGS. 5a and 5b show the completed spar 1 incorporated in part of a wing structure. In this drawing, the full extent of the legs 3, 4 of the spar 1 are shown. As can be seen, the legs 3, 4 comprise the majority of the overall length of the spar 1. The main body 2 of the spar 1 comprises a first end portion, arranged to protrude from the wing structure and arranged to lie in a first plane (labelled A in FIG. 6). The main body 2 provides support and load transmission for the root of the wing structure. The legs 3, 4 extend along a portion of the span of the wing structure. The legs 3, 4, are of different lengths, and the leg 4 extends almost to the tip of the wing structure. The respective free end portions 3d, 4d of the legs 3, 4 are arranged to lie in a second plane (labelled B in FIG. 6), with the spar curving along the transition region between the two planes.

In this embodiment, the wing structure comprises a winglet 9. A winglet is a device that is attached to the tip of an aircraft wing in order to improve the aerodynamic performance of the aircraft in flight. The winglet 9 comprises a lower skin 10, a plurality of reinforcing ribs 11 on the lower skin and the spar 1 arranged to extend along the span of the winglet 9. The ribs 11 may be integrally formed with the lower skin 10. A second spar 12 is also provided in order to give structural support to the front portion of the winglet 9—that is to say, the portion adjacent the leading edge of the winglet in flight. The winglet 9 also includes an erosion shield 12 arranged to protect the leading edge.

FIG. 6 shows a fully formed winglet 9, which includes all of the features shown in FIGS. 5a and 5b, with the addition of an upper skin 13 forming the upper aerodynamic surface of the winglet. The winglet 9 is almost completely formed of composite material, with only a small number of parts, such as the erosion shield 12, being formed of metallic material. The main body 2 of the spar 1 protrudes from the assembled winglet 9 and provides the main attachment point of the winglet to the main body of a wing.

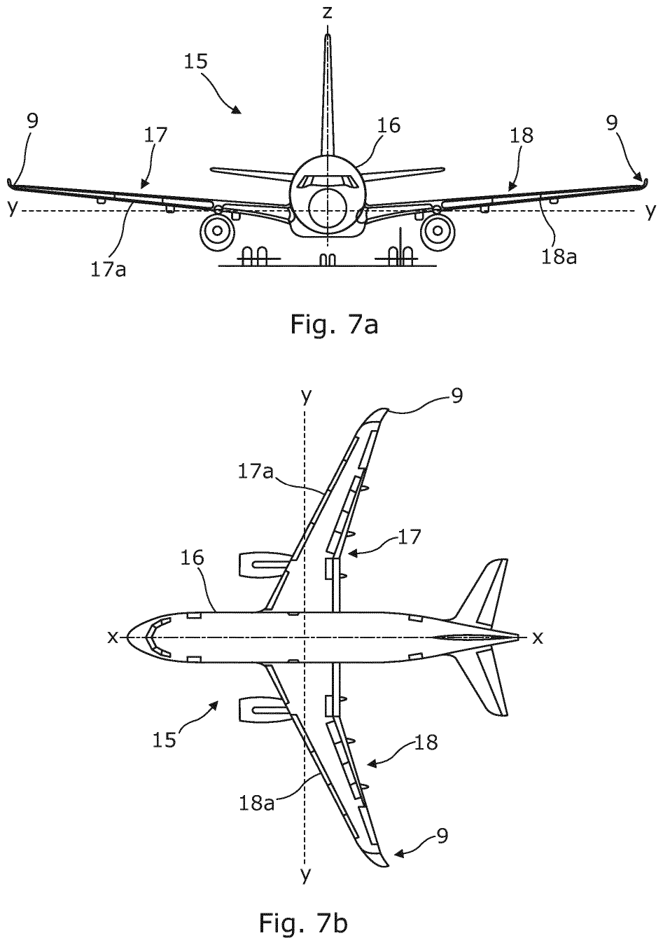

A winglet with a smooth curve, such as that shown in the drawings, is known as a blended winglet. Blended winglets are intended to reduce interference drag at the junction between the main body of the wing and the winglet. FIGS. 7a and 7b show such a winglet incorporated in an aircraft. The aircraft, indicated generally by the reference numeral 13, comprises a fuselage 14 and a pair 15, 16 of wings. Each wing comprises a wing main body 15a, 16a and a winglet 9. The wing main bodies 15a, 16a produce lift for the aircraft and also house fuel tanks (not visible in these drawings). The wing main bodies may also incorporate leading edge devices, such as slats, and trailing edge devices such as flaps. Each winglet 9 is attached to the tip of its respective wing main body 15a, 16a, with the protruding part of the main body 2 of the spar 1 being located inside the interior of the wing main body. Each winglet 9 is arranged to provide an upwardly curving wing tip. In flight, the winglets 9 increase the lift generated at the wingtip by smoothing the airflow across the upper wing near the tip. The winglets also reduce the lift-induced drag caused by wingtip vortices, improving lift-to-drag ratio.

Variations may be made without departing from the scope of the invention. For example, the main body of the spar 1 need not be completely hollow: internal webs may be employed to provide further stiffness, or even a solid body may be used. The cross section of the main body 2 of the spar 1 need not be rectangular: it may be square, rounded or have another polygonal shape.

The legs 3, 4 may be parallel to each other or they may be arranged to splay outwardly from the main body 2 of the spar 1. The legs 3, 4 of the spar shown in this embodiment have different lengths; naturally, the spar can be made to have legs of the same length. Preferably, the legs 3, 4 are arranged to conform to the contours of the structure to which the spar gives support. The legs 3, 4 may have other shapes of cross-section, provided that they are designed with sufficient space for moving the mandrel parts out of engagement with the finished spar. The legs 3, 4 may be arranged to have different respective cross sections. More legs may be provided to extend from the main body, if required.

The spar of the present invention has been described in the context of providing a support structure for a winglet arranged at the tip of the wing; however, the spar may be used on the main body of a wing, with the main body 2 of the spar 1 delivering a mechanical and structural link between the wing and the fuselage of the aircraft. The spar of the present invention may alternatively be used in turbine blades, rotary wings, propellers, fan blades or other structures requiring internal structural support. Further variations will be apparent to the person skilled in the art.

1. A composite spar, comprising:
a main body; and,
a pair of spaced apart legs, in which the spar follows a curved path which does not lie in a single plane.

2. A spar as claimed in claim 1, in which a first end portion of the spar comprises the main body in a first plane; and the other end portion comprises the end portions of the legs in a second plane and the spar further comprises a curved transition region between the planes.

3. A spar as claimed in claim 1, in which at least part of the main body is hollow.

4. A spar as claimed in claim 1, in which the legs are concave in section, with the openings facing each other.

5. A spar as claimed in claim 4, in which each leg has a c-shaped cross section.

6. A spar as claimed in claim 1, in which the main body is rectangular in cross section.

7. A method of forming a composite spar as claimed in claim 1, comprising the steps of: laying a fabric on a mandrel assembly; laying a die assembly over the fabric; injecting liquid resin into the fabric and curing the fabric by applying an elevated temperature.

8. A method as claimed in claim 7, in which the mandrel assembly includes a main body mandrel arranged to form the main body of the spar and which is slidably removable from the spar.

9. A method as claimed in claim 7, in which the mandrel assembly includes a plurality of mandrel segments arranged to form the legs of the spar, each segment being slidably removable from the spar.

10. A method as claimed in claim 9, in which the mandrel segments are arranged, in use, to fit against each other.

11. A wing structure including a composite spar as claimed in claim 1.

12. A wing structure as claimed in claim 11, arranged to follow a curved path which does not lie in a single plane.

13. A wing structure as claimed in claim 11, in which the main body of the spar is arranged to support the wing structure at its root.

14. A wing structure as claimed in claim 11, in which the legs are arranged to support the wing structure along at least part of its span.

15. A wing structure as claimed in claim 11, in which the wing structure is a wing tip device.

16. An aircraft wing comprising a wing main body and a wing tip device as claimed in claim 15.

17. An aircraft wing as claimed in claim 16, in which a portion of the composite spar extends from the wing tip and is located inside the wing main body.

18. An aircraft wing as claimed in claim 17, in which the portion of the composite spar comprises the main body.

19. An aircraft including a wing structure as claimed in claim 11.
